(19) United States
(12) Patent Application Publication
(10) Pub. No.: US 2009/0288237 A1
(43) Pub. Date: Nov. 26, 2009

(54) Flexible Glove and the Preparation Method Thereof

(75) Inventor: Qiang Chen, Shanghai (CN)

Correspondence Address: GLOBAL IP SERVICES, 7285 W. Eagle Court, Winton, CA, 95388, US

(73) Assignee: Aquatech Speciality (Shanghai) International Trading Co., Ltd., Shanghai (CN)

(21) Appl. No.: 12/126,517

(22) Filed: May 23, 2008

(51) Int. Cl. A41D 19/00; B29C 43/52

(52) U.S. Cl. 2/161.7; 2/168; 264/319

(57) ABSTRACT

The present invention relates to a flexible glove prepared from a composition of waterborne polyurethane resin and waterborne acrylic resin, together with a cure-crosslinking agent, to prepare a flexible glove. The flexible glove, prepared by using this specific waterborne resin mixture and the crosslinking agent, after adding one kind of nano-calcium carbonate slurry, have excellent service performance and reasonable preparation cost. During the preparation, 10˜100 portions of waterborne acrylic resin, 0.1˜0.5 portions of amino resin crosslinking agent and 5˜20 portions of nano-calcium carbonate slurry are added to 100 portions of waterborne polyurethane. The present invention also relates to the preparation method of this particular flexible glove.

### FIELD OF THE INVENTION

The present invention relates to a glove, particularly discloses a flexible glove and the preparation method thereof.

### BACKGROUND OF THE INVENTION

Flexible waterproof gloves are commonly used in medical treatment and industrial production, and can be made from flexible vinyl-based plastomer, natural rubber (NR), acrylonitrile butadiene rubber (NBR), polyurethane elastomer and etc.

Gloves made from NR latex wear comfortable and have perfect strength. But the containing protein may cause allergic to human body. The comfortability and strength of gloves made from flexible vinyl-based plastomer, despite its low cost, are inferior to the rubber elastomer-based gloves. Besides, large amount of solvent and plasticizer used during the production are not environmentally friendly. As to the gloves made from NBR, it has excellent strength, but without satisfactory wearing comfortability.

The flexible waterproof gloves, prepared from polyurethane dispersion, possess perfect wearing comfortability and strength, and are consistent with modern environmental protection requirements. However, the polyurethane dispersion costs high and its alcohol resistance is poor.

Besides, the curing agent and accelerator added during the production of gloves using NR latex and NBR increase the health hazards to human beings. However, no curing agent or curing accelerator is contained in the flexible glove produced by the present invention.

Publication No. CN101003165A disclosed a method of preparing gloves from NBR-polyurethane composite film, which does not improve any intrinsic properties of NBR gloves directly. U.S. Pat. No. 5,997,969 disclosed a method for waterborne polyurethane-based gloves production. The method uses waterborne polyurethane merely which causes high-cost. Furthermore, no any relevant comparative data, especially the important data of alcohol resistance, are given.

### SUMMARY OF THE INVENTION

The purpose of the present invention is to overcome the problems in prior art and provides a preparation method of flexible gloves with perfect wearing comfortability, high strength and low cost, while keeping it in accordance with the environmental protection requirements.

The present invention can be achieved through the following preparation method:
(A) 100 portions (by weight) of at least one of anionic aliphatic polyurethane dispersions;
(B) 10˜100 portions (by weight) of at least one of self-reactive acrylic emulsions or solutions;
(C) 0.1˜0.5 portions (by weight) of a cure-crosslinking agent, said cure-crosslinking agent is an aqueous or alcoholic solution of amino resin;
(D) 0˜10 portions (by weight) of waterborne pigment color slurry composition;
(E) 5˜20 portions (by weight) of a nano-calcium carbonate slurry;
(F) an agglomerant;
(G) a waterborne coating;
(H) acid and alkali cleaning agents.

Comprising the preparation steps of:

(1) Cleanse the hand-mould by the alkali cleaning agent of (H), followed by the acid cleaning agent of (H), then by 50˜90° C. hot water;

(2) Dry the above-mentioned cleansed hand-mould under 100˜120° C. atmosphere for 3˜5 min;

(3) Immerse the above-mentioned dried hand-mould in 1˜30% (w/w) of (F), preferably in 5˜15% (w/w), then dry it under 80˜110° C. atmosphere for 3˜5 min;

(4) Immerse the above-mentioned dried hand-mould into the pre-mix of (A), (B), (C), (D) and (E) for 5˜7 seconds, and then cure the mould under 110˜150° C. atmosphere for 20˜60 seconds;

(5) Immerse the above-mentioned hand-mould in a dilute solution of (G), the dilution ratio (by weight) is 5˜15 times compared to (F); then cure the mould under 110˜150° C. atmosphere for 10˜20 min;

(6) Cleanse the treated hand-mould in 50° C. warm water and leach, then cure the mould under 110˜150° C. atmosphere for 3˜10 min then demould to thereby obtain the flexible glove.

The said agglomerant is an aqueous solution of inorganic salts, selected from one or more of calcium chloride, calcium nitrate, magnesium chloride and magnesium nitrate or the composition thereof. The content of the inorganic salt falls in the range of 2˜20% by weight, preferably in 5˜10%.

The said waterborne coating is a self-made product, mainly made from a solution of water-borne polyurethane dispersion and a modified polysiloxane surfactant.

The said acid cleaning agent is a dilute solution of any strong acids, such as hydrochloride (HCl), sulfuric acid (H₂SO₄), etc, the pH is controlled<4. The said alkali cleaning agent is a dilute solution of any strong bases, such as sodium hydroxide (NaOH), ammonium hydroxide (NH₄OH) and potassium hydroxide (KOH), the pH is controlled>10.

Flexible gloves prepared by the above-mentioned procedures contain the following components:
(A) 100 portions (by weight) of at least one of anionic aliphatic polyurethane dispersions;
(B) 10˜100 portions (by weight) of at least one of self-reactive acrylic emulsions or solutions;
(C) 0.1˜0.5 portions (by weight) of cure-crosslinking agent, said cure-crosslinking agent is an aqueous or alcoholic solution of amino resin;
(D) 0˜10 portions (by weight) of waterborne pigment color slurry composition;
(E) 5˜20 portions (by weight) of nano-calcium carbonate slurry.

The said polyurethane dispersion having an elongation of >500%, a tensile strength of >15 MPa, σ₁₀₀<3.5 MPa and a glass transition temperature of T_{g}<20° C., can be chosen from the Impranil® DLN waterborne polyurethane dispersion W 50, W40, Impranil® LP RSC1380 waterborne polyurethane dispersion from Bayer MaterialScience, Sancare 20025 from Lubrizol Advanced Materials Corporation, and etc.

The said self-reactive acrylic emulsion or solution is a waterborne acrylic emulsion or solution, preferably in 20-60 portions (by weight) having as elongation of >500%, σ₁₀₀<3.5 MPa and T_{g}<20° C. It can be chosen from HYCAR®26345, HYCAR®26349, HYCAR®26089, HYCAR®2671, HYCAR®2679, HYCAR® T122 from Lubrizol Advanced Materials Corporation, Craymul 3210, 3240 and 3250 from Cray Valley Corporation, and etc.

The said cure-crosslinking agent is an aqueous or alcoholic solution of amino resin, selected from one or more of hexamethoxy melamine resin, high imino type amino resin, etherized amino resin and phenyl amino resin or the composition thereof preferably in 0.15˜0.3 portions (by weight) such as CYMEL™303 , CYMEL™370 and CYMEL™385 from Cytec Industries Incorporation or the composition thereof.

The median diameter of the dispersion particle size of the waterborne pigment color slurry composition is smaller than 1 micron and the composition is compatible with the mixtures of (A), (B) and (C), preferably in 0˜5 portions (by weight). It can be chosen from commercially available DuPont™ Ti-Pure® R-706, DuPont™ Ti-Pure® R-902 from Dupont Titanium Technologies (Shanghai) Co., Ltd, or Phthalocyanine Blue B, Phthalocyanine Blue BGS slurry from Hangzhou Sunshine Chemicals Co., Ltd.

The weight content of the said nano-calcium carbonate slurry, for example, F-50 nano-calcium carbonate for coating from Shandong Haize Nanomaterials Co., Ltd, is 50% of the oleo stock, preferably in the range of 7˜15 portions.

The advantages of the present invention are as follows:

The flexible glove related to this invention maintains the merits of flexible glove made from polyurethane dispersion and improves the production cost;

The curing agent, consisting of aqueous or alcoholic solution of amino resin enormously, remarkably increases the alcohol resistance performance of the flexible glove made from polyurethane resin;

The addition of calcium carbonate slurry substantially lowers the cost.

### BRIEF DESCRIPTION OF THE DRAWINGS

FIG. 1 shows the preparation flowchart of the flexible glove of the present invention.

### DETAILED DESCRIPTION OF THE INVENTION

### EXAMPLE 1

(A) 327 g of Impranil® DLN waterborne polyurethane dispersion W 50;

(B) 163 g of HYCAR® T122;

(C) 3.6 g of ethanolic solution of CYMEL™ 385 (50% w/w);

(D) 7.2 g of Phthalocyanine Blue B slurry (50%, w/w), and 40 g of Ti-Pure® R-706 slurry (50%, w/w).

First uniformly mix (A) and (B), then subsequently add (C) and (D) to the mixture and disperse them until a homogeneous mixture is obtained. Add water to the mixture up to 1000 g. Finally thoroughly mix to obtain a mixture, which is referred to as EXAMPLE 1.

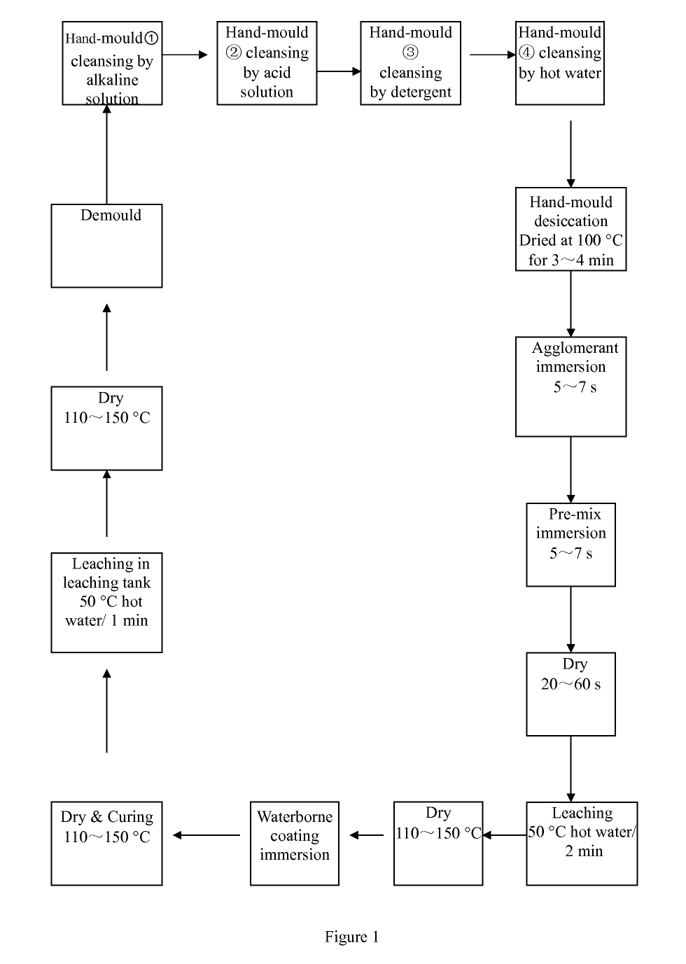

Flexible gloves are produced according to the implementing procedure (FIG. 1) of the present invention by using the composition of EXAMPLE 1. The agglomerant utilized here is an aqueous solution of calcium nitrate (6%, w/w), and the acid and alkali cleaning agents are HCl solution (pH≈2) and NaOH solution (pH≈12), respectively. The prepared gloves are compared with commercially available ones and the results are shown in Table-1. It can clearly seen that the elasticity of the gloves made from EXAMPLE 1 is substantially superior to gloves made from NBR and polyvinyl chloride (PVC), and is close to the ones made from NR latex and polyurethane. However, the gloves of the present invention do not contain proteins allergic to human as compared to gloves made from rubber latex, and have much higher alcohol resistance as compared to gloves from polyurethane.

### EXAMPLE 2

The feed ratio of the waterborne polyurethane dispersion and acrylic emulsion in Example 1 is adjusted to 374 g and 115 g in EXAMPLE 2 and 408 g and 81 g in EXAMPLE 3, respectively, while the other parameters are kept constant. The measured results are shown in Table-2. It can be seen from Table-2 that addition of acrylic emulsion slightly decreased the strength but increased the flexibility and elongation. The cost was effectively reduced.

### EXAMPLE 3

Impranil® DLN waterborne polyurethane dispersion W 50 was combined with HYCAR®26345, HYCAR®26349 and Craymul 3240, respectively, while the other components and their feed ratio the same as EXAMPLE 2, to produce EXAMPLE 4, EXAMPLE 5 and EXAMPLE 6. Impranil® LP RSC1380 was used as a substitute for Impranil® DLN waterborne polyurethane dispersion W 50, and mixed with HYCAR®T122, HYCAR®26345, HYCAR®26349 and Craymul 3240 under the same conditions as EXAMPLE 2, to produce EXAMPLE 7, EXAMPLE 8, EXAMPLE 9 and EXAMPLE 10. The results are shown in Table-3.

TABLE 1
a comparison of the sample gloves with commercially available gloves

| | | | | | | Alcohol |
|---|---|---|---|---|---|---|
| | Tensile | | | | | Resistance |
| | Strength | Elongation | σ₁₀₀ | σ₂₀₀ | σ₃₀₀ | Retention |
| Sample Name | MPa | (%) | MPa | MPa | MPa | Rate (%) |
| EXAMPLE 1 | 16.73 | 720 | 1.63 | 2.04 | 3.06 | 53.2 |
| NBR Gloves | 11.37 | 385 | 1.74 | 2.36 | 4.48 | 60 |
| PVC Gloves | 12.78 | 333 | 4.87 | 7.39 | 12.78 | 90.6 |
| NR Gloves | 18.42 | 683 | 0.79 | 1.15 | 1.72 | 72.4 |
| Polyurethane | 18.70 | 900 | 0.92 | 1.21 | 1.53 | 12.0 |
| Gloves | | | | | | |

TABLE 2

| | | | | | | Alcohol |
|---|---|---|---|---|---|---|
| | Tensile | | | | | Resistance |
| | Strength | Elongation | σ₁₀₀ | σ₃₀₀ | σ₅₀₀ | Retention |
| Sample Name | MPa | (%) | MPa | MPa | MPa | Rate (%) |
| EXAMPLE 1 | 16.73 | 720 | 1.63 | 3.06 | 5.21 | 53.2 |
| EXAMPLE 2 | 19.17 | 658 | 1.79 | 3.72 | 6.08 | 51.7 |
| EXAMPLE 3 | 19.66 | 633 | 2.03 | 4.03 | 6.42 | 50.7 |

TABLE 3

| | Tensile Strength | Elongation | σ₁₀₀ | σ₃₀₀ | σ₅₀₀ |
|---|---|---|---|---|---|
| Sample Name | MPa | (%) | MPa | MPa | MPa |
| EXAMPLE 1 | 16.73 | 720 | 1.63 | 3.06 | 5.21 |
| EXAMPLE 4 | 23.92 | 653 | 2.10 | 4.62 | 7.56 |
| EXAMPLE 5 | 22.88 | 550 | 2.20 | 4.61 | 7.96 |
| EXAMPLE 6 | 16.16 | 625 | 1.63 | 3.09 | 5.21 |
| EXAMPLE 7 | 21.15 | 645 | 2.05 | 4.32 | 6.31 |
| EXAMPLE 8 | 23.42 | 610 | 2.27 | 4.71 | 7.68 |
| EXAMPLE 9 | 19.23 | 533 | 2.56 | 5.29 | 9.15 |
| EXAMPLE 10 | 26.50 | 600 | 2.25 | 4.27 | 6.84 |

### Preparation Procedure of Each Example:

(1) Cleanse the hand-mould by the alkali cleaning agent of (H), followed by the acid cleaning agent of (H), then by 50˜90° C. hot water;

(2) Dry the above-mentioned cleansed hand-mould under 100˜120° C. atmosphere for 3˜5 min;

(3) Immerse the above-mentioned dried hand-mould in 1˜30% (w/w) of (F), preferably in 5˜15% (w/w), then dry it under 80˜110° C. atmosphere for 3˜5 min;

(4) Immerse the above-mentioned dried hand-mould into the pre-mix of (A), (B), (C), (D) and (E) for 5˜7 seconds, and then cure the mould under 110˜150° C. atmosphere for 20˜60 seconds;

(5) Immerse the above-mentioned hand-mould in a dilute solution of (G), the dilution ratio is 5˜15 times (by weight) compared to (F); then cure the mould under 110˜150° C. atmosphere for 10˜20 min;

(6) Cleanse the treated hand-mould in 50° C. warm water and leach, then cure the mould under 110˜150° C. atmosphere for 3˜10 min, then demould to thereby obtain the flexible gloves.

1. A preparation method of flexible gloves comprising the following preparation steps:
(A) 100 portions (by weight) of at least one of anionic aliphatic polyurethane dispersions;
(B) 10˜100 portions (by weight) of at least one of self-reactive acrylic emulsions or solutions;
(C) 0.1˜0.5 portions (by weight) of cure-crosslinking agent, said cure-crosslinking agent is an aqueous or alcoholic solution of amino resin;
(D) 0˜10 portions (by weight) of waterborne pigment color slurry composition;
(E) 5˜20 portions (by weight) of a nano-calcium carbonate slurry;
(F) an agglomerant;
(G) a waterborne coating;
(H) acid and alkali cleaning agents;
(1) cleanse hand-moulds by the alkali cleaning agent of (H), followed by the acid cleaning agent of (H), then by 50˜90° C. hot water;
(2) dry the hand-moulds cleansed in step (1) under 100˜120° C. atmosphere for 3‥5 min;
(3) immerse the hand-moulds dried in step (2) in 1˜30% (w/w) of (F), preferably 5˜15% (w/w), then dry it under 80˜110° C. atmosphere for 3˜5 min;
(4) immerse the dried hand-moulds immersed in step (3) into a premix of (A), (B), (C), (D) and (E) for 5˜7 seconds, and then cure the moulds under 110˜150° C. atmosphere for 20˜60 seconds;
(5) immerse the hand-moulds cured in step (5) in a dilute solution of (G), the dilution ratio (by weight) is 5˜15 times compared to (F); then cure the moulds under 110˜150° C. atmosphere for 10˜20 min;
(6) cleanse the hand-mould cured in step (5) in 50° C. warm water and leach, then cure the mould under 110˜150° C. atmosphere for 3˜10 min, then demould to thereby obtain the flexible gloves.

2. The method according to claim 1, wherein said agglomerant is an aqueous solution of inorganic salts selected from calcium chloride, calcium nitrate, magnesium chloride and magnesium nitrate, or compositions thereof.

3. Flexible gloves comprising components of:
(A) 100 portions (by weight) of at least one of anionic aliphatic polyurethane dispersions;
(B) 10˜100 portions (by weight) of at least one of self-reactive acrylic emulsions or solutions;
(C) 0.1˜0.5 portions (by weight) of cure-crosslinking agent;
(D) 0˜10 portions (by weight) of waterborne pigment color slurry composition;
(E) 5˜20 portions (by weight) of nano-calcium carbonate slurry.

4. The flexible gloves according to claim 3, wherein the polyurethane dispersions of (A) have an elongation of >500%, a tensile strength of >15 MPa, a 100% tensile strength of σ₁₀₀<3.5 MPa and a glass transition temperature of T_{g}<20° C.

5. The flexible glove according to claim 3, wherein the self-reactive acrylic emulsions or solutions are a waterborne acrylic emulsions or solutions having an elongation of >500%, a σ₁₀₀<3.5 MPa and a glass transition temperature of T_{g}<20° C.

6. The flexible glove according to claim 3, wherein the cure-crosslinking agent is an aqueous or alcoholic solution of amino resin, selected from hexamethoxy melamine resin, high imino type amino resin, etherized amino resin and phenyl amino resin or compositions thereof.

7. The flexible glove according to claim 3, wherein the median diameter of the dispersion particles of the waterborne pigment color slurry composition is smaller than 1 micron and the waterborne pigment color slurry composition is compatible with the mixtures of (A), (B) and (C).
